(19) United States
(12) Patent Application Publication
(10) Pub. No.: US 2012/0158816 A1
(43) Pub. Date: Jun. 21, 2012

(54) SERVICE PROVIDING METHOD AND DEVICE USING THE SAME

(75) Inventors: Hyun Hwa CHOI, Daejeon (KR); Young Chang KIM, Daejeon (KR); Byoung Seob KIM, Daejeon (KR); Myung Cheol LEE, Daejeon (KR); Dong Oh KIM, Seoul (KR); Hun Soon LEE, Daejeon (KR); Mi Young LEE, Daejeon (KR)

(73) Assignee: Electronics and Telecommunications Research Institute, Daejeon (KR)

(21) Appl. No.: 13/325,301

(22) Filed: Dec. 14, 2011

(30) Foreign Application Priority Data
Dec. 15, 2010 (KR) 10-2010-0128579

(51) Int. Cl. G06F 9/46; G06F 15/16

(52) U.S. Cl. 709/201; 718/102

(57) ABSTRACT

Disclosed are service providing method and device, including: collecting execution state information about a plurality of tasks that constitute at least one service, and are dynamically distributed and arranged over a plurality of nodes; and performing scheduling based on the collected execution state information about the plurality of tasks, wherein each of the plurality of tasks has at least one input source and output source, and a unit of data to be processed for each input source and a data processing operation are defined by a user, and the scheduling is to delete at least a portion of data input into at least one task or to process the at least a portion of input data in at least one duplicate task by referring to the defined unit of data. In particular, the present invention may effectively provide a service of analyzing and processing large stream data in semi-real time.

### CROSS-REFERENCE TO RELATED APPLICATIONS

This application claims priority to and the benefit of Korean Patent Application No. 10-2010-0128579 filed in the Korean Intellectual Property Office on Dec. 15, 2010, the entire contents of which are incorporated herein by reference.

### TECHNICAL FIELD

The present invention relates to a service providing method and device, and more particularly, to a service providing method and device that may effectively provide a service of analyzing and processing large stream data in semi-real time into consideration of various application environments.

### BACKGROUND ART

With the advent of a ubiquitous computing environment and with the rapid development in a user-oriented Internet service market, an amount of data to be processed is rapidly increasing and types of data are also being more diversified. Accordingly, various researches on processing of distributed data are ongoing in order to provide a service of analyzing and processing large data in semi-real time.

As one of the various researches on processing of distributed data, FIG. 1 is a schematic diagram showing an example of a distributed parallel processing structure for processing large data according to a related art.

Referring to FIG. 1, a service 110 includes a single input source (INPUT SOURCE1) 100 and a single output source (OUTPUT SOURCE1) 130, and is executed by a plurality of nodes (NODE1, NODE2, NODE3, NODE4, and NODE5) 111, 112, 113, 114, and 115 that are entities to process data from the input source 100.

The service 110 may be defined by defining a data flow graph through combination of provided operators. Here, the data flow graph may be expressed by definition of a plurality of data processing operators (OP1, OP2, OP3, OP4, and OP5) 116, 117, 118, 119, and 120 that are present in the plurality of nodes (NODE1, NODE2, NODE3, NODE4, and NODE5) 111, 112, 113, 114, and 115, respectively, and a directed acyclic graph (DAG) that describes a data flow among the plurality of data processing operators (OP1, OP2, OP3, OP4, and OP5) 116, 117, 118, 119, and 120.

As described above, the service 110 is distributed and arranged over the plurality of nodes (NODE1, NODE2, NODE3, NODE4, and NODE5) 111, 112, 113, 114, and 115 within a cluster and thereby is executed in parallel, thereby enabling a relatively fast service support with respect to, particularly, large data.

Hereinafter, a distributed parallel processing system for conventional large data processing based on the aforementioned distributed parallel processing structure will be described.

Initially, a well-known Borealis system is a system suitable for distributed and parallel processing of stream data and provides various operators, for example, a union, a filter, a tumble, a join, and the like, for stream data processing. The Borealis system performs distributed parallel processing with respect to large stream data by arranging operators, constituting a service, over distributed nodes to be parallel executed. However, only processing of normalized data is enabled and a service for the processing stream data is defined only as combination of built-in operators, for example, a filter, a tumble, a join, and the like, provided from the Borealis system. Accordingly, there are some constraints on a complex service technology and it is difficult to adopt a user optimization technology of a data processing operation according to a service characteristic.

Meanwhile, a MapReduce system is a distributed parallel processing system proposed by Google to support a distributed processing operation with respect to large data stored in a cluster including a large number of nodes with inexpensive cost. The MapReduce system supports such that a user may define a map and reduce operation, and enables the map and reduce operation to be duplicated to a multi-node as a multitask, thereby enabling large data to be distributed and parallel processed.

A dryad system is a distributed parallel processing system based on a data flow graph expanded compared to the MapReduce system. In the dryad system, a user may configure a service by describing a data processing operation as a vertex and expressing a data transfer between vertices as a channel. In general, the vertex may correspond to a node and the channel may correspond to an edge or a line. The dryad system enables large data to be parallel processed by dynamically distributing and arranging vertices based on load information about nodes within the cluster, in order to quickly execute a service registered/defined by the user.

Meanwhile, a Hadoop online system enables the user to obtain processing result data in the middle of processing by overcoming a disadvantage in that the user was able to obtain a processing result only after all of the map and reduce operation for large data of the dryad system is completed.

However, in the Hadoop online system, only storage data stored in a file within a cluster, instead of stream data, is a target to be processed, only a fixed map and reduce operation is provided, and a variety of methods capable of obtaining a processing result from an application are not supported.

Accordingly, the related art cannot efficiently provide a service of analyzing and processing large stream data in semi-real time into consideration of various application environments.

### SUMMARY OF THE INVENTION

The present invention has been made in an effort to provide a service providing method and device that may efficiently provide a service of analyzing and processing large stream data in semi-real time into consideration of various application environments.

The present invention has been made in an effort to provide a service providing method and device that may continuously perform parallel processing of data by dynamically distributing and arranging data processing operations defined by a user over a plurality of nodes.

An exemplary embodiment of the present invention provides a service providing method, including: collecting execution state information about a plurality of tasks that constitute at least one service, and are dynamically distributed and arranged over a plurality of nodes; and performing scheduling based on the collected execution state information about the plurality of tasks, wherein each of the plurality of tasks has at least one input source and output source, and a unit of data to be processed for each input source and a data processing operation are defined by a user, and the scheduling is to delete at least a portion of data input into at least one task or to process the at least a portion of input data in at least one duplicate task by referring to the defined unit of data.

The scheduling may be performed based on data segmentation related information including the number of data segmentations defined in each of the plurality of tasks and a data segmentation method, or may be performed based on data deletion related information including an amount of data to be deleted defined in each of the plurality of tasks and a criterion for selecting data to be deleted.

The scheduling may further include: determining whether there is a service that does not satisfy a quality of service (QoS) based on the collected execution state information about the plurality of tasks; selecting a cause task when there is the service; and performing scheduling for the selected task.

Here, in the scheduling for the selected task, at least a portion of input data may be deleted based on resource usage state information about the plurality of tasks, or may be processed in at least one duplicate task of the selected task.

Another exemplary embodiment of the present invention provides a service providing device, including: a service executor managing module to collect execution state information about a plurality of tasks that constitute at least one service, and are dynamically distributed and arranged over a plurality of nodes; and a scheduling and arranging module to perform scheduling based on the collected execution state information about the plurality of tasks, wherein each of the plurality of tasks has at least one input source and output source, and a unit of data to be processed for each input source and a data processing operation are defined by a user, and the scheduling is to delete at least a portion of data input into at least one task or to process the at least a portion of input data in at least one duplicate task by referring to the defined unit of data.

The scheduling may be performed based on data segmentation related information including the number of data segmentations defined in each of the plurality of tasks and a data segmentation method, or may be performed based on data deletion related information including an amount of data to be deleted defined in each of the plurality of tasks and a criterion for selecting data to be deleted.

The scheduling and arranging module may determine whether there is a service that does not satisfy a QoS based on the collected execution state information about the plurality of tasks, may select a cause task when there is the service, and may perform scheduling for the selected task.

In the scheduling for the task, at least a portion of input data may be deleted based on resource usage state information about the plurality of tasks, or may be processed in at least one duplicate task of the selected task.

The service providing device may further include: a service managing module to control the overall data distribution processing; and a task recovery module to recover and execute again a task when a task error occurs. In addition, each of the plurality of nodes may include a single task executor. The task executor may collect execution state information and resource usage state information about at least one task positioned in each of the plurality of nodes to transfer the collected execution state information and resource usage state information to the service providing device, and may control execution of the at least one task according to scheduling of the service providing device.

The task executor may perform scheduling separate from scheduling of the service providing device and thereby controlling execution thereof.

Scheduling in the task executor may change a task execution order in order to satisfy a QoS set for each task.

Yet another exemplary embodiment of the present invention provides a service providing method, including: transmitting an execution request for a service defined by a user; and receiving the service executed in response to the execution request, wherein the execution of the service includes: collecting execution state information about a plurality of tasks that constitute the service and that are dynamically distributed and arranged over a plurality of nodes; and performing scheduling based on the collected execution state information about the plurality of tasks, wherein each of the plurality of tasks has at least one input source and output source, and a unit of data to be processed for each input source and a data processing operation are defined, and the scheduling is to delete at least a portion of data input into at least one task or to process the at least a portion of input data in at least one duplicate task by referring to the defined unit of data.

According to exemplary embodiments of the present invention, the following effects may be obtained.

First, according to the configuration of the present invention, it is possible to support a distributed and continuous service which is to process large stream data and storage data having various forms coming from the various application environments.

Second, it is possible to minimize a decrease in a processing performance due to a change in a network environment or a significant increase in input data. Third, a user under various application environments may receive a service of processing atypical stream data and guaranteeing a QoS designated by the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram illustrating an example of a distributed parallel processing structure for processing large data according to a related art.

FIG. 2 is a schematic diagram illustrating an example of a distributed parallel processing structure for processing large data according to an exemplary embodiment of the present invention.

FIG. 3 is a schematic diagram illustrating an example of a distributed parallel processing structure for processing large data according to another exemplary embodiment of the present invention.

FIGS. 4A, 4B, and 4C are functional block diagrams of a service manager, a task executor, and a task of FIG. 3, respectively, according to an exemplary embodiment of the present invention.

FIG. 5 is a flowchart schematically illustrating a process of registering and executing a service defined by a user according to an exemplary embodiment of the present invention.

FIG. 6 is a flowchart illustrating an execution process performed in a task according to an exemplary embodiment of the present invention.

FIG. 7 is a flowchart illustrating a process of global scheduling performed by a service manager according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following exemplary embodiments are combined with constituent components and features of the present invention in a predetermined form. Each of the constituent components or features may be selectively considered unless it is explicitly mentioned. Each of the constituent components or features may be implemented without combination with other constituent components or features. Further, a portion of the constituent components or features may be combined with each other, thereby constituting the exemplary embodiments of the present invention. Orders of operations described in the exemplary embodiments of the present invention may be changed. A portion of configurations or features of an exemplary embodiment may be included in another exemplary embodiment, or may be replaced with a configuration or a feature corresponding to the other exemplary embodiment.

The exemplary embodiments of the present invention may be configured through various means. For example, the exemplary embodiments of the present invention may be configured by hardware, firmware, software, combinations thereof, and the like.

In the case of configuration by hardware, a method according to exemplary embodiments of the present invention may be configured by at least one of application specific integrated circuits (ASICs), digital signal processors (DSPs), digital signal processing devices (DSPDs), programmable logic devices (PLDs), field programmable gate arrays (FPGAs), processors, controllers, micro controllers, micro processors, and the like.

In the case of configuration of firmware or software, a method according to exemplary embodiments of the present invention may be configured in a form of a module, a procedure, a function, and the like, performing the aforementioned functions or operations. A software code may be stored in a memory unit and be driven by a processor. The memory unit may be positioned inside or outside the processor to transmit and receive data to and from the processor through the known various means.

Predetermined terms used in the following description are provided to help the understanding of the present invention and uses of the predetermined terms may be modified in another form without departing from the scope of the technical fields of the present invention.

Hereinafter, exemplary embodiments of the present invention will be described in detail with reference to the accompanying drawings.

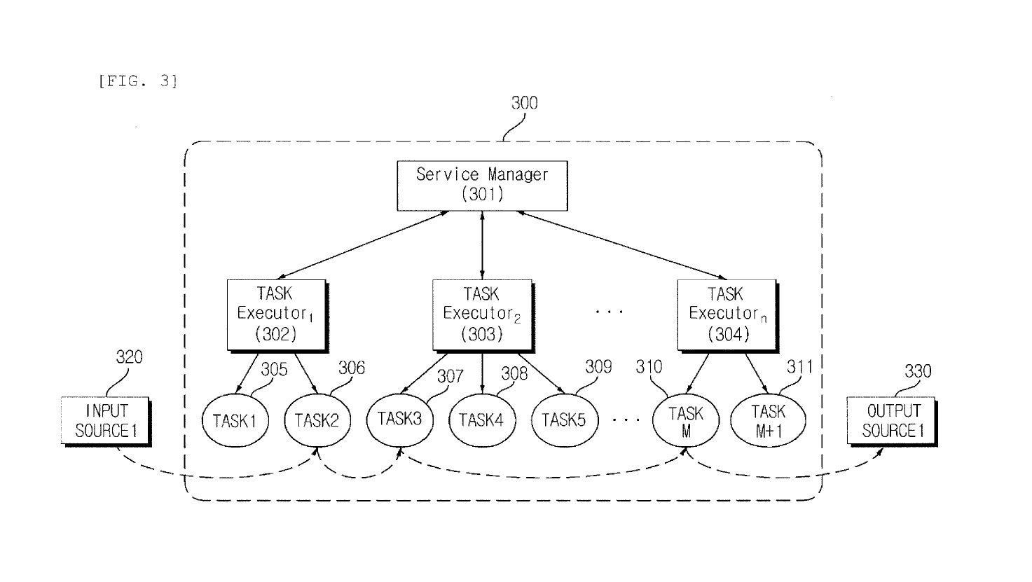

FIG. 2 is a schematic diagram illustrating an example of a distributed parallel processing structure for processing large data according to an exemplary embodiment of the present invention.

Referring to FIG. 2, a data processing system 210 according to the present invention is a system for distributed parallel processing of large stream data and/or storage data in order to execute services 220 and 230 that include a plurality of nodes (NODE1, NODE2, NODE3, NODE4, NODE5, NODE6, and NODE7) 211, 212, 213, 214, 215, 216, and (TASK1, TASK2, TASK3, TASK4, TASK5 and TASK6) 221, 222, 223, 224, 231 and 232 of which data processing operations are defined by a user.

Similarly as described above, the services 220 and 230 may be defined by defining a data flow graph. Here, the data flow graph may be expressed by definition of the plurality of tasks (TASK1 to TASK6) and a directed acyclic graph (DAG) that describe a data flow among the plurality of tasks (TASK1 to TASK6). The plurality of tasks 221 to 224, 231, and 232 correspond to a plurality of data processing operations that are present in the plurality of node (NODE1 to NODE7) 211 to 217, respectively. A user defined input/output source as well as a file or a network source may be used for at least one service input source (INPUT SOURCE1 and INPUT SOURCE2) 200 and 201 and/or at least one service output source (OUPUT SOURCE1 and OUTPUT SOURCE2) 240 and 241 of the data processing system 210. A format of data on the at least one service input/output source may be an identifier based record, a key-value record, a CR based text, a file, and/or user defined input/output form.

Each of the plurality of tasks 221 to 224, 231, and 232 may have at least one input source and output source. Here, in the case of general tasks, an input source is a foregoing task and an output source is a following task and depending on cases, an input source and an output source of a service may be an input source and an output source of a task. For example, the task 221 has the input source 200 of the service as an input source and the task 224 has the output source 240 of the service as an output source. Also, the plurality of tasks 221 to 224, 231, and 232 may be defined with a general-purpose developed language. Here, the definition may include a definition about a unit of stream data, that is, a data window, which is a target to be processed for each input source. In this instance, the data window may be set based on a time unit or a data unit. A time unit may be a predetermined time interval and a data unit may be the number of data, or the number of events. In addition, a sliding unit for data window configuration of subsequent data processing may also be set together.

Meanwhile, the definition of the plurality of tasks 221 to 224, 231, and 232 may include, for example, data segmentation related information in preparation for a significant increase in input data. The data segmentation related information may be, for example, a data segmentation method, the number of data segmentations, and/or guide information for the data segmentation method. Here, the data segmentation method may be one of segmentation methods such as a random, a round robin, a hash, and the like.

Alternatively, the definition of the plurality of tasks 221 to 224, 231, and 232 may include, for example, information associated with compulsory load shedding, that is, data deletion related information, in preparation for the significant increase in input data. The data deletion related information may be, for example, an amount of data to be deleted and/or a criterion for selecting data to be deleted. The amount of data to be deleted may be described a rate of input data that can be allowed to be deleted. Also, data to be deleted may include the whole data bound to a data window or a portion of data within a data window.

Meanwhile, for example, in the case of defining the service 230, the user may define a data flow between tasks including the predetermined task 221 of the service 220 being executed. This is to optimize a resource use within the data processing system 210 by sharing an operation processing result of data.

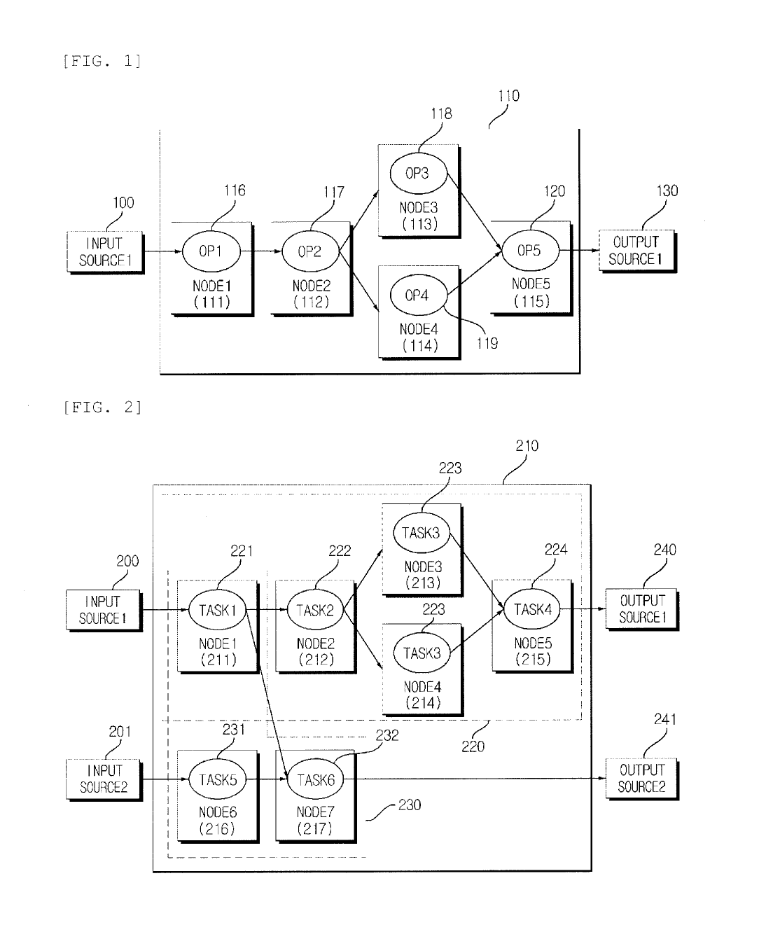

Similarly as described above with reference to FIG. 1, in the case of the services 220 and 230 defined by the user, the plurality of tasks 221 to 224, 231, and 232 constituting the services 220 and 230 are dynamically distributed and arranged over the plurality of nodes 211 to 217 within the cluster and thereby are executed. Here, the dynamic distribution and arrangement of the plurality of tasks 221 to 224, 231, and 232 is performed by referring to load information about the plurality of nodes 211 to 217 constituting the cluster. The load information may be system load information including a usage rate of a central processing unit (CPU), a memory, a network bandwidth, and the like, and/or service load information such as a data input rate of tasks being executed in a node, a processing rate, a predicted satisfaction level of QoS information, and the like.

Since the predetermined task 221 transfers a processing result to all of the following tasks 222 and 232 alike depending on whether a task is shared, an operation with respect to the same data is supported to not be unnecessarily repeated.

After the service execution, for example, when stream data significantly increases, a decrease in a service processing performance is minimized by parallel processing stream data in some nodes 213 and 214 among the plurality of nodes 211 to 217 through duplication of the task 223. Here, the optimal number of tasks to be duplicated may be dynamically determined by referring to data segmentation related information such as the number of data segmentations associated with a corresponding task within a service definition and a data segmentation method.

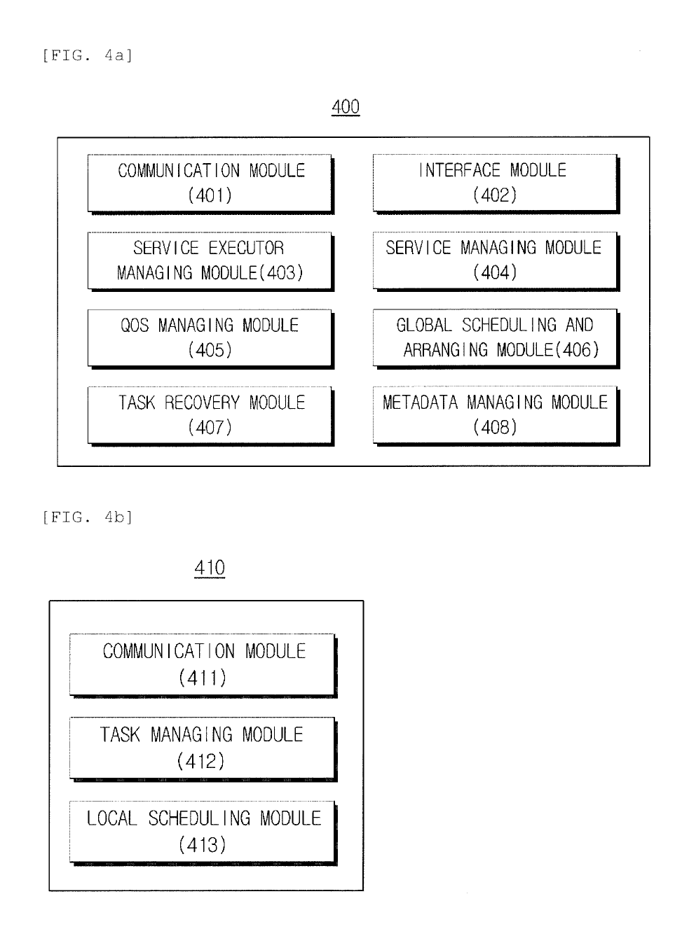

FIG. 3 is a schematic diagram illustrating an example of a distributed parallel processing structure for processing large data according to another exemplary embodiment of the present invention. Here, only the difference is that FIG. 2 is a diagram illustrated from view of a service definition and FIG. 3 is a diagram illustrated from view of a service execution and thus, it should be understood that FIG. 2 and FIG. 3 do not conflict with each other or are not incompatible.

Referring to FIG. 3, a data processing system 300 includes a single service manager 301 and n task executors (TASK Executor₁, TASK Executor₂, . . . , TASK Executorₙ) 302, 303, . . . , 304, which can be executed in distributed nodes (not shown), respectively.

The service manager 301 monitors or collects load information that includes operational state information of the task executors 302 to 304, execution state information about a task managed by each of the task 302 to 304, and/or resource usage state information about a corresponding distributed node, and the like. When an execution request for a service defined by a user is received, the service manager 301 may execute the service by determining the task executors 302 to 304 to execute tasks of the requested service based on the collected load information, and arranging the tasks. Also, the service manager 301 may schedule execution of the whole tasks based on the collected load information.

The task executors 302 to 304 execute tasks (TASK1, TASK2, TASK3, TASK4, TASK5, . . . , TASKM, TASKM+1) 305, 306, 307, 308, 309, 310, and 311 that are allocated from the service manager 301, and schedule execution of the tasks 305 to 311 by monitoring execution states of the tasks 305 to 311.

Meanwhile, the tasks 305 to 311 executed through the task executors 302 to 304 receive data from an external input source (INPUT SOURCE1) 320 and transfer a task execution result to an external output source (OUTPUT SOURCE1) 330. For example, the task (TASK2) 306 receives data from the external input source 320 to perform an operation, and transfers a corresponding result to the task (TASK3) 307 that is a following task. The task (TASK3) 307 performs an operation with respect to the result data received from the task (TASK2) 306 and then transfers a corresponding result to the task (TASKM) 310. Meanwhile, the task (TASKM) 310 transfers an operation performance result to the external output source 330.

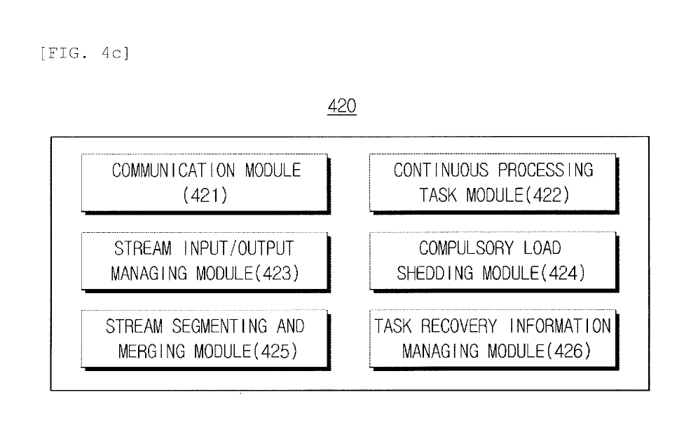

FIGS. 4A, 4B, and 4C are functional block diagrams of a service manager, a task executor, and a task of FIG. 3, respectively, according to an exemplary embodiment of the present invention.

Referring to FIG. 4A, a service manager 400 may include a communication module 401, an interface module 402, a service executor managing module 403, a service managing module 404, a QoS managing module 405, a global scheduling and arranging module 406, a task recovery module 407, and a metadata managing module 408.

Here, the communication module 401 functions to communicate with a user of a data processing system and a task executor 410. The interface module 402 provides an interface enabling the user to perform an operation and management such as start and stop of the data processing system according to the present invention in an application program and a console, and an interface enabling the user to define and manage a data processing service according to the present invention.

The service executor managing module 403 collects execution state information about a started task executor and detects whether the task executor is in an error state, and thereby informs the global scheduling and arranging module 406 to perform global scheduling.

The service managing module 404 controls the overall process, for example, service verification, registration, execution, suspension, change, deletion, and the like, in which a service defined by the user is separated into a plurality of tasks according to a data flow and thereby is distributively executed over a plurality of nodes. Also, the service managing module 404 collects execution state information about a task being executed and detects whether the task is in an error state or in an unsmooth execution state (continuous unsatisfactory QoS state) and thereby informs the global scheduling and arranging module 406 to perform global scheduling.

The QoS managing module 405 manages QoS information in order to maximally guarantee the goal of QoS for each service. Here, the QoS information may be, for example, the accuracy of a service, a delay level of the service, an allowable QoS satisfaction level, and the like.

To maximally satisfy a QoS set by the user, the global scheduling and arranging module 406 performs task scheduling based on the QoS information, execution state information of services, and resource usage state information of the nodes in a cluster system. The task scheduling may include a task distribution, movement, and duplication, a control of a task execution time, and deletion of input data, and the like.

The task recovery module 407 functions to recover and re-execute a task in the case of an error of the task executor 410 and an error of the task 420. The task recovery module 407 may include a function of selectively recovering task data. Meanwhile, the error recovery of the service manager 400 is performed through a method of dualizing the service manager 400 in the form of an active-standby mode, or selecting a single master service manager from a plurality of candidate service managers. The recovery of the service manager enables a service of continuous processing system like the present invention to be provided seamlessly. Description relating to a structure and a function of a recovery module of the service manager 400 will be omitted here.

The metadata managing module 408 stores and manages metadata such as service information, QoS information, server information, and the like.

Referring to FIG. 4B, the task executor 410 includes a communication module 411, a task managing module 412, and a local scheduling module 413.

The communication module 411 is used to receive execution state information from tasks being at least executed among tasks that are managed by the task executor 410, and to transfer, to the service manager 400, the received execution state information about tasks being executed and/or resource usage state information about a node. The task managing module 412 executes a task that is allocated from the service manager 400, and collects the execution state information about the tasks 420 being at least executed and the resource usage state information about the node in which the task executor 410 is executed.

The local scheduling module 413 controls execution of tasks to be executed, based on local QoS information transferred from the service manager 400 and/or a task execution state control command. Here, the local QoS information is QoS information associated with only tasks managed by the task executor 410 and may be a data processing rate, a processing delay time, and the like, which are similar to the aforementioned (global) QoS information. The task execution state control command may be a new task execution, suspension of a task being executed, information about a change in a system resource (for example, a memory, a CPU, and the like) allocated to the task and/or compulsory load shedding through input data deletion of the task, and the like.

The local scheduling module 413 manages local scheduling information and inspects whether QoS is satisfied at a task level. That is, the local scheduling module 413 monitors or collects execution state information about the task. To maximally satisfy the local QoS, the task executor 410 may perform independent scheduling of determining an execution order of a task being executed, and the like.

Referring to FIG. 4C, the task 420 includes a communication module 421, a continuous processing task module 422, a stream input/output managing module 423, a compulsory load shedding module 424, a stream segmenting and merging module 425, and a task recovery information managing module 426.

The communication module 421 functions to perform communication in order to transfer execution state information about a corresponding task to the task executor 410 that manages the task 420, and to control task operation.

The continuous processing task module 422 executes a data processing operation defined by a user based on data that is input via the stream input/output managing module 423, and outputs an execution result to a subsequent task or an external output source via the stream input/output managing module 423. The stream input/output managing module 423 manages a user defined input/output source including a file, a transmission control protocol (TCP), and the like, an input/output channel between tasks, an input/output data format, and a data window about input/output data.

The compulsory load shedding module 424 provides a load shedding function by, for example, compulsorily deleting at least a portion of stream data bound to a data window of a corresponding task according to control of the local scheduling module 413 of the task executor 410 that manages the task.

When one task is required to be duplicated to at least one duplicate task, the stream segmenting and merging module 425 provides a function of segmenting an input data stream of the task based on a data window unit and transferring the segmented input data stream to the at least one duplicate task including the task, and provides a function of merging data streams that are output by performing an operation in the task and the at least one duplicate task. Here, the at least one duplicate task may be present in the same node, or each of the at least one duplicate task may be present in a different node.

In preparation for error recovery of the task, the task recovery information managing module 426 provides a function of storing and managing information required for data recovery until a final result about the stream data window bound to the task being processed is computed.

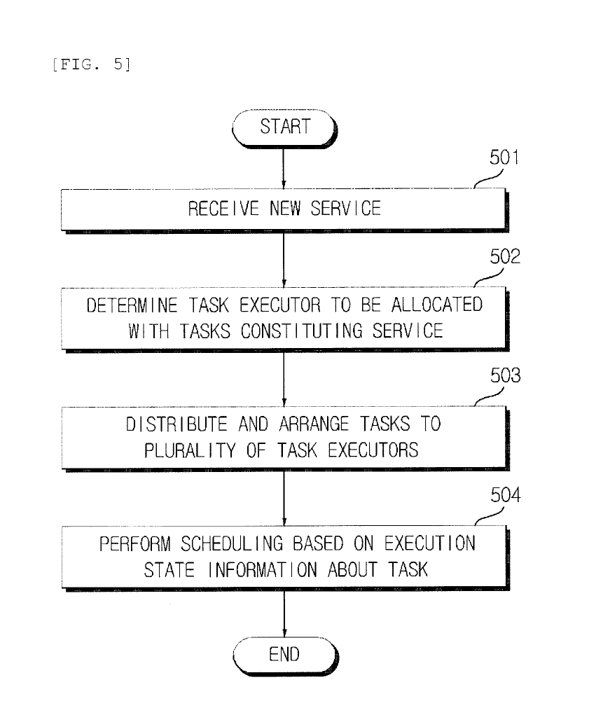

FIG. 5 is a flowchart schematically illustrating a process of registering and executing a service defined by a user according to an exemplary embodiment of the present invention.

When a new service established by a user definition is registered to a data processing system according to the present invention (501). At least one task executor is selected based on resource usage state information about a plurality of nodes and execution state information about tasks being executed (502). Tasks are distributed and arranged and thereby are executed by allocating the tasks to a task executor of the selected node (503). Next, to satisfy QoSs of services, a service manager dynamically performs continuous scheduling of tasks based on execution state information about tasks that is periodically collected (504).

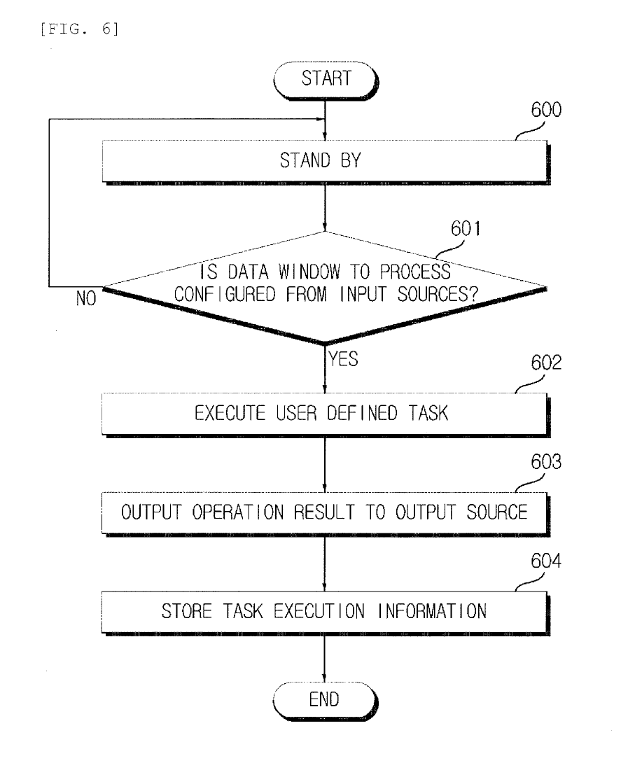

Here, an operation of at least one task among the tasks will be described with reference to FIG. 6. As shown in FIG. 6, a task inspects whether all the data window of the input sources with a task are satisfied (601). When all the data window is satisfied, the task executes a user defined task (602) and otherwise stands by (600). When an operation result is obtained by executing the user defined task, the task transfers the operation result to at least one output source (603). Here, execution state information about the corresponding task is stored to enable recovery of the task and to provide execution state information (604).

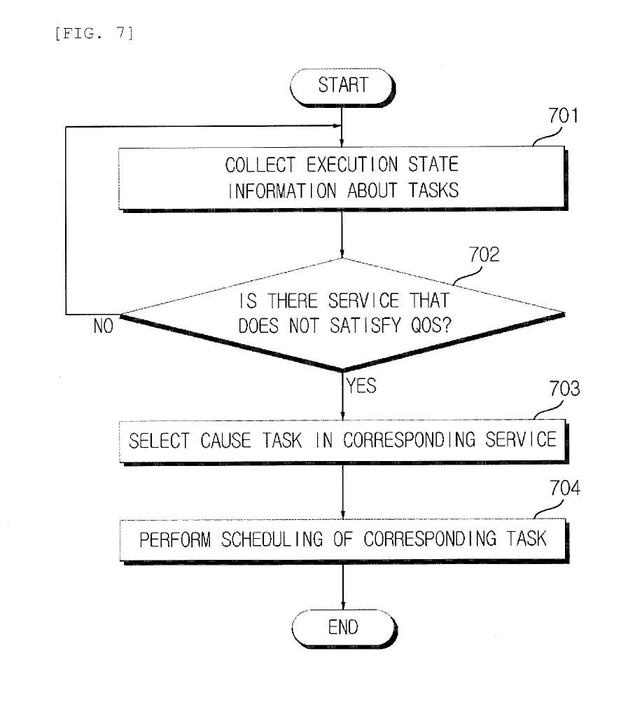

FIG. 7 is a flowchart illustrating a process of global scheduling performed by a service manager according to an exemplary embodiment of the present invention.

The service manager collects execution state information about at least one task periodically (701). The service manager inspects whether there is a service that does not satisfy a QoS defined by a user based on the collected information (702). When all of services satisfy the QoS, the service manager collects execution state information about subsequent tasks (701). When there is a service that does not satisfy the QoS, the service manager selects a cause task (703) and performs scheduling with respect to the selected task (704).

Here, scheduling of the selected task that does not satisfy the QoS may be performed through, for example, the following process. Initially, the service manager performs scheduling by allocating some extra system resources to the task. When there are no extra resources in a corresponding node in which the selected task is being executed, the service manager searches for another node having extra resources enough to smoothly execute the task. When the other node having the extra resource is found, the service manager moves the corresponding task from the corresponding node in which the task is being executed to the other node having the extra resource. When the other node having the extra resource is not found, the service manager segments an input data stream and duplicates the selected task to a plurality of other distributed nodes and thereby enables the selected task to be executed in the duplicated other distributed nodes. That is, the service manager performs scheduling so that resources of a plurality of nodes may be shared and thereby be used. Meanwhile, when movement and duplication of the task is impossible, the aforementioned compulsory shedding method may be applied to the selected task.

Here, description relating to a function and a structure of each of constituent components of a data processing system according to the present invention that includes a service manager, at least one task executor, at least one task, and at least one node as at least a portion of a device for providing a service defined by a user, and lower constituent components thereof may be employed as is to a service providing method according to the present invention.

A service providing device and method of the present invention may be applicable to any technical field that needs to analyze and process large stream data in real time, for example, a real-time personalization service or recommendation service in various application environments including an Internet service, a closed circuit television (CCTV) based security service, and the like.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A service providing method, comprising:
collecting execution state information about a plurality of tasks that constitute at least one service, and are dynamically distributed and arranged over a plurality of nodes; and
performing scheduling based on the collected execution state information about the plurality of tasks,
wherein each of the plurality of tasks has at least one input source and output source, and a unit of data to be processed for each input source and a data processing operation are defined by a user, and the scheduling is to delete at least a portion of data input into at least one task or to process the at least a portion of input data in at least one duplicate task by referring to the defined unit of data.

2. The method of claim 1, wherein the scheduling is performed based on data segmentation related information including the number of data segmentations defined in each of the plurality of tasks and a data segmentation method.

3. The method of claim 1 or 2, wherein the scheduling is performed based on data deletion related information including an amount of data to be deleted defined in each of the plurality of tasks and a criterion for selecting data to be deleted.

4. The method of claim 1, wherein the scheduling further comprises:
determining whether there is a service that does not satisfy a quality of service (QoS) based on the collected execution state information about the plurality of tasks;
selecting a cause task when there is the service; and
performing scheduling for the selected task.

5. The method of claim 4, wherein, in the scheduling for the selected task, at least a portion of input data is deleted based on resource usage state information about the plurality of tasks, or is processed in the selected task or at least one duplicate task of the selected task.

6. A service providing device, comprising:
a service executor managing module to collect execution state information about a plurality of tasks that constitute at least one service, and are dynamically distributed and arranged over a plurality of nodes; and
a scheduling and arranging module to perform scheduling based on the collected execution state information about the plurality of tasks,
wherein each of the plurality of tasks has at least one input source and output source, and a unit of data to be processed for each input source and a data processing operation are defined by a user, and the scheduling is to delete at least a portion of data input into at least one task or to process the at least a portion of input data in at least one duplicate task by referring to the defined unit of data.

7. The device of claim 6, wherein the scheduling is performed based on data segmentation related information including the number of data segmentations defined in each of the plurality of tasks and a data segmentation method.

8. The device of claim 6, wherein the scheduling is performed based on data deletion related information including an amount of data to be deleted defined in each of the plurality of tasks and a criterion for selecting data to be deleted.

9. The device of claim 6, wherein the scheduling and arranging module determines whether there is a service that does not satisfy a QoS based on the collected execution state information about the plurality of tasks, selects a cause task when there is the service, and performs scheduling for the selected task.

10. The device of claim 9, wherein, in the scheduling for the selected task, at least a portion of input data is deleted based on resource usage state information about the plurality of tasks, or is processed at least one duplicate task of the selected task.

11. The device of claim 6, further comprising:
a service managing module to control the overall data distribution processing; and
a task recovery module to recover and execute again a task when a task error occurs.

12. The device of claim 6, wherein each of the plurality of nodes includes a single task executor, and the task executor collects execution state information and resource usage state information about at least one task positioned in each of the plurality of nodes to transfer the collected execution state information and resource usage state information to the service providing device, and controls execution of the at least one task according to scheduling of the service providing device.

13. The device of claim 12, wherein the task executor is capable of performing scheduling separate from scheduling of the service providing device and thereby controlling execution thereof.

14. The device of claim 13, wherein scheduling in the task executor is to change a task execution order in order to satisfy a QoS set for each task.

15. A service providing method, comprising:
transmitting an execution request for a service defined by a user; and
receiving the service executed in response to the execution request,
wherein the execution of the service comprises:
collecting execution state information about a plurality of tasks that constitute the service, and are dynamically distributed and arranged over a plurality of nodes; and
performing scheduling based on the collected execution state information about the plurality of tasks,
wherein each of the plurality of tasks has at least one input source and output source, and a unit of data to be processed for each input source and a data processing operation are defined by a user, and the scheduling is to delete at least a portion of data input into at least one task or to process the at least a portion of input data in at least one duplicate task by referring to the defined unit of data.
